(19) United States
(12) Patent Application Publication
(10) Pub. No.: US 2019/0282047 A1
(43) Pub. Date: Sep. 19, 2019

(54) HEAD OF VACUUM CLEANER

(71) Applicant: Samsung Electronics Co., Ltd., Suwon-si, Gyeonggi-do (KR)

(72) Inventors: Keiichi MINAMIDE, Machida (JP); Hirohisa MIYAZAKI, Ota-ku (JP); Mitsuhiro SHIGERI, Yokohama Midori-ku (JP); Masato SUZUKI, Inamachi (JP)

(21) Appl. No.: 16/075,950

(22) PCT Filed: Feb. 2, 2017
(86) PCT No.: PCT/KR2017/001134

§ 371 Date: Aug. 6, 2018

(30) Foreign Application Priority Data
Feb. 5, 2016 (JP) 2016-020924
Apr. 6, 2016 (KR) 10-2016-0042065

(51) Int. Cl. A47L 9/06; B08B 5/04

(52) U.S. Cl. CPC A47L 9/0613; A47L 9/0666; B08B 5/04

(57) ABSTRACT

A vacuum cleaner head capable of implementing a plurality of functions having different cleaning purposes and capable of changing the cleaning mode, thereby performing efficient cleaning without inconvenience is provided.

The vacuum cleaner head includes a first part having a first air passage communicating with a main air passage of a cleaner main body, a second part having a plurality of cleaner function units provided at different positions and a plurality of second air passages communicating between each of the cleaner function units and the first air passage. The second part is connected to the first part so that the inclination angle of the second part is changeable in multiple steps. By changing the inclination angle of the second part with respect to the first part, some of the plurality of cleaner function units is disposed so as to be usable and the second air passage is communicated with the first air passage for switching to the portion of the plurality of cleaner function units to be used.

### CROSS-REFERENCE TO RELATED APPLICATIONS AND CLAIM OF PRIORITY

This application is a 371 National Stage of International Application No. PCT/KR2017/001134 filed Feb. 2, 2017, which claims priority to Japanese Application No. JP 2016-020924, filed Feb. 5, 2016 and Korean Patent Application No. KR 10-2016-0042065, filed Apr. 6, 2016 the disclosures of which are herein incorporated by reference in their entirety.

### BACKGROUND

### 1. Field

The present disclosure relates to a vacuum cleaner head implementing a plurality of functions.

### 2. Description of Related Art

Conventional vacuum cleaner heads have various shapes, and various cleaning functions can be implemented by using vacuum cleaner heads suited for cleaning purposes.

Generally, a vacuum cleaner is provided with two types of suction ports, a normal suction port and a crevice suction port. The suction port of the cleaner is provided so that two hollow heads can be opened and closed to the left and right at the tip of the pipe. When the two hollow heads are opened, the suction pork can be used as the normal suction port. When the two hollow heads are opposed to each other and closed, the shape of the suction port can be modified so that it can be used as the clearance suction port.

However, when changing the cleaning mode to change the function, such as a. vacuum cleaner ead having a broom brush and a vacuum cleaner head having a suction port, it was necessary to replace the vacuum cleaner head from the cleaner main body.

In order to do this, since the vacuum cleaner head must be changed in accordance with the purpose of cleaning, it was not efficient because of inconvenience caused by the exchange operation.

### SUMMARY

The present disclosure is directed to providing a vacuum cleaner head capable of implementing a plurality of functions having different cleaning purposes and capable of changing the cleaning mode, thereby performing efficient cleaning without inconvenience.

One aspect of the present disclosure provides a vacuum cleaner head including a first part having a first air passage communicating with a main air passage of a cleaner main body, and a second part having a plurality of cleaner function units provided at different positions and a plurality of second air passages communicating between each of the cleaner function units and the first air passage, the second part being connected to the first part so that the inclination angle of the second part is changeable in multiple steps, wherein by changing the inclination angle of the second part with respect to the first part, some of the plurality of cleaner function units is disposed so as to be usable and the second air passage is communicated with the first air passage for switching to the some of the plurality of cleaner function units to be used.

By changing the inclination angle of the second part having a plurality of cleaner function units, it may be possible to switch to the cleaner function unit to be used. Accordingly, it may be possible to implement a plurality of cleaning functions with a single vacuum cleaner head, and it may be possible to perform efficient cleaning by omitting a head exchange operation for each cleaning function.

Particularly, by changing the inclination angle of the second part, some of the plurality of cleaner function units can be used and the corresponding second air passages may be communicated with the first air passage. Accordingly, it may be easy to install a plurality of cleaner function units having different cleaning functions on the second part and the cleaning mode can easily be changed by a single vacuum cleaner head.

Therefore, it may be possible to implement a plurality of functions having different cleaning purposes, and the cleaning mode can be changed, so that the cleaning can be efficiently performed without inconvenience.

The second part may be provided so as to be able to select one of a fixed posture in which the inclination angle of the second part is not changed and a variable posture in which the inclination angle of the second part is changeable.

The cleaner function unit to be used can be fixedly disposed in the fixed posture and the cleaner function unit to be used can be freely tilted in the variable posture. This may make it easy to implement the function of each cleaner function unit by appropriately selecting the posture according to the function of the cleaner function unit to be used.

The fixed posture and the variable posture may be provided so that the inclination directions of the second part with respect to the first part are different from each other.

It may be therefore possible to select the cleaner function unit to be used by appropriately adjusting the inclination angle of the second part with respect to the first part and to arrange the second part in a state according to the function of the cleaner function unit. Accordingly, the selection and placement of the cleaner function unit can be performed at the same time by adjusting the inclination angle of the second part, so that efficient cleaning can be performed without further troubles.

The plurality of cleaner function units may include; a broom function unit having a broom brush portion and a broom suction port opened adjacent to the broom brush portion and a normal cleaning function unit having a normal suction port, wherein the broom function unit may be configured to be usable in the fixed posture and the normal cleaning function unit may be configured to be usable in the variable posture.

Since the broom function unit having the broom brush portion can be used as the fixed posture, the inclination angle of the broom brush portion may be not changed. Therefore, the broom brush portion can be accurately contacted at a desired position, thereby making it easy to perform the broom-cleaning.

Since the normal cleaning function unit having the normal suction port can be used as the variable posture, may be easy to keep the normal cleaning function unit in a state where the normal cleaning function unit is arranged along the floor when the dust of the floor is sucked while the normal cleaning function unit is moved. Therefore, it is easy to clean the floor.

It may be convenient to use in any cleaning mode.

The second part may have a flat shape and the broom brush portion may be provided on a front end surface corresponding to the thickness of the second part.

Therefore, when the broom function unit is arranged to be usable and the vacuum cleaner head is moved along the long-side of the second part, even a narrow gap corresponding to the thickness of the second part can be broom-cleaned.

Meanwhile, by moving the second part of the vacuum cleaner head in the short-side direction of the side surface, it may be possible to perform broom-cleaning of the wide floor.

Therefore, even a narrow gap or the wide floor F can be cleaned by broom-cleaning.

At least a portion of the brush bristles of the broom brush portion may serve as the fixed brush portion of the normal cleaning function unit, so that the number of components can be regulated.

The broom brush portion may be provided as an attachment brush detachably coupled to a second part main body connected to the first part and configured to change the inclination angle in multiple steps.

When deterioration occurs by use of the brush bristles of the broom brush portion, only the attachment brush may be replaced and the second part main body can be used as it is. Accordingly, the vacuum cleaner head can be used for a long period of time.

The second part main body may be provided with a release button releasing the attachment brush, so that the attaching/detaching of the attachment brush is easy.

The vacuum cleaner head may have a position regulator regulating the position of the second part in the oblique direction and the position regulator may have a foot button releasing regulation of the second part to change inclination angle of the second part by being pressed with the foot.

The second part can be moved to another inclined angle position by releasing the position regulation of the inclination angle of the second part by pressing the foot button with the foot. Thus, the adjustment of the position of the inclination angle of the second part can be performed by using the foot, so that the operation can be simplified.

According to the vacuum cleaner head of the present embodiment, some of the plurality of cleaner function units is disposed so as to be usable by changing the inclination angle of the second part, and the on air passage can be communicated with the first air passage. Therefore, it is easy to install the plurality of cleaner function units, each having a cleaning function which greatly different in cleaning purpose from the others, on the same second part, and the cleaning mode can easily be changed by a single vacuum cleaner head.

It is possible to implement a plurality of functions having different cleaning purposes and capable of changing the cleaning mode, thereby performing efficient cleaning without inconvenience.

### BRIEF DESCRIPTION OF THE DRAWINGS

FIG. 1 is a perspective view of a vacuum cleaner head according to an embodiment of the present disclosure, illustrating a state in which a broom function unit is arranged so as to be usable.

FIG. 2 is a side view of the vacuum cleaner head according to an embodiment of the present disclosure, illustrating g a state in which the broom function unit is arranged so as to be usable.

FIG. 3 is a cross-sectional view of the vacuum cleaner head according to an embodiment of the present disclosure, illustrating a state in which the broom function unit is arranged so as to be usable.

FIG. 4 is a perspective view of the vacuum cleaner head according to an embodiment of the present disclosure, illustrating a state in which a normal cleaning function unit is arranged so as to be usable.

FIG. 5 is a side view of the vacuum cleaner head according to an embodiment of the present disclosure, illustrating a state in which the normal cleaning function unit is arranged so as to be usable.

FIG. 6 is a cross-sectional view of the vacuum cleaner head according to an embodiment of the present disclosure, illustrating a state in which the normal cleaning function unit is arranged so as to be usable.

FIG. 7 is a view illustrating an operation of a position regulator of the vacuum cleaner head according to an embodiment of the present disclosure, particularly, 7A shows a state in which a second part is arranged in a fixed posture, 7B shows a state in which the position regulation is released, 7C shows a state in which the second part is inclined to a variable posture after releasing the position regulation, and 7D shows a state in which the second part is arranged in the variable posture.

FIG. 8 is a perspective view illustrating a state where an attachment brush is detached from a broom brush portion of the vacuum cleaner head according to an embodiment.

FIG. 9 is a perspective view illustrating a state in which the broom function unit of the vacuum cleaner head according to an embodiment is used.

FIG. 10 is a perspective view illustrating a state in which the normal cleaning function unit of the vacuum cleaner head according to an embodiment is used.

FIG. 11 is a side view illustrating a state in which the normal cleaning function unit of the vacuum cleaner head according to an embodiment is used.

### DETAILED DESCRIPTION

Hereinafter, a vacuum cleaner head according to an embodiment of the present disclosure will be described with reference to the drawings.

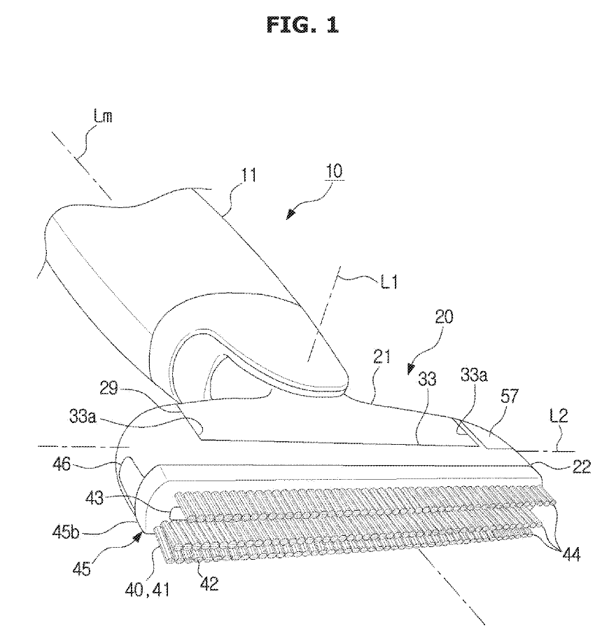

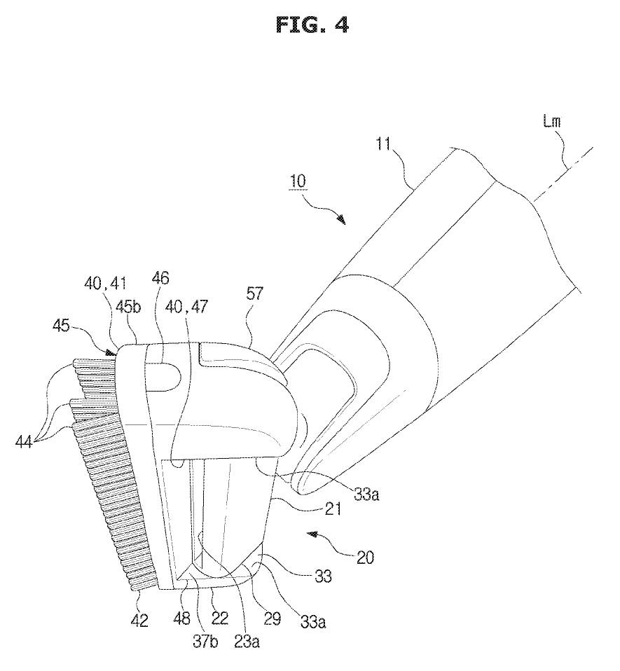

FIG. 1 to FIG. 3 are a perspective view, a side view and a longitudinal cross-sectional view of a vacuum cleaner head according to air embodiment of the present disclosure respectively, illustrating a state in which a broom function unit is arranged so as to be usable. FIG. 4 to FIG. 6 are a perspective view, a side view and a longitudinal cross-sectional view of the vacuum cleaner head according to an embodiment of the present disclosure respectively, illustrating a state in which a normal cleaning function unit is arranged so as to be usable.

According to the embodiment of the present disclosure, the vacuum cleaner 10 includes a cleaner main body 11 and a vacuum cleaner head 20 directly connected to the cleaner main body 11.

In the present embodiment, the cleaner main body 11 is installed along an axis Lm in a longitudinal direction, and a suction motor or the like is mounted at a position close to the vacuum cleaner head 20, and a handle or the like (not shown) is provided on a separated side from the vacuum cleaner head 20.

The center of gravity is set at a position close to the vacuum cleaner head 20, and the user uses the vacuum cleaner while holding the handle in a state where the vacuum cleaner head 20 is disposed downward.

The vacuum cleaner head 20 has a first part 21 connected to the cleaner body 11 and a second part 22 connected to the first part 21.

The first part 21 has a first air passage therein and communicates with a main air passage 13 of the cleaner main body 11 by an air passage connecting portion 25.

One side of the first part 21 is connected to the cleaner main body 11 through a first hinge portion 27. In the first hinge portion 27, the first part 21 is freely rotatable about a first rotation axis L1 orthogonal to the axis Lm.

The other side of the first part 21 is connected to the second part 22 through a second hinge portion 29. In the second hinge portion 29, the second part 22 can be rotatable about a second rotation axis L2 so as to be inclined with respect to the first part 21. The second rotation axis L2 is orthogonal to the axis Lm while the second rotation axis L2 is spaced apart from the first rotation axis L1 and orthogonal to the first rotation axis L1.

The second hinge portion 29 is provided with an arc-shaped portion 31 having a constant radius of curvature about the second rotation axis L2 and extending along the second rotation axis L2. A communicating passage 23a of the first air passage 23 is provided in the arc-shaped portion 31 so as to penetrate along the axis Lm.

The second part 22 is formed in a flat shape having a wide width along the second rotation axis 12 and a thickness along the first rotation axis L1 that is narrower than the vertical width along the axis Lm.

A connecting concave portion 33 along the second rotation axis L2 is provided concavely in the middle of the lateral width in the direction of the axis Lm. The arc-shaped portion 31 of the second hinge portion 29 is accommodated between an inner side portions 33a on both sides in the width direction of the connecting concave portion 33 so that the second part 22 is connected to the first part 21 via the second hinge portion 29.

An arcuate groove 35 is formed along the second rotation axis L2 at a portion connected with the arc-shaped portion 31 of the second hinge portion 29 in the second part 22. The arcuate groove 35 and the outer surface of the arc-shaped portion 31 of the second hinge portion 29 are in contact with each other so as to be rotatable.

On the outer surface side of the second part 22, a plurality of cleaner function units 40 are provided at different positions in a direction inclining with respect to the second rotation axis L2. In the present embodiment, the plurality of cleaner function units 40 includes a broom function unit 41 for suctioning dust or waste while performing broom-cleaning and a normal cleaning function unit 47 for sucking dust or waste from a floor while moving along the floor or the like.

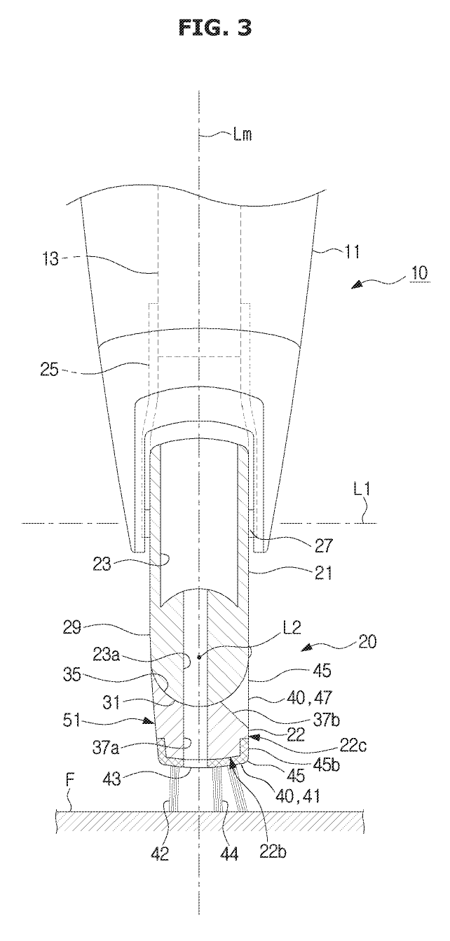

The broom function unit 41 is provided on one of a front end surfaces 22b (see FIG. 3) corresponding to the thickness of the second part 22 and is provided with a broom brush portion 42 and a broom suction port 43 formed on the front end surface 22b of the second part 22 adjacent to the broom brush portion 42 and communicating with the opening of the second air passage 37a. The vicinity of the broom brush portion 42 may be a position where the dust on the floor F contacting the broom brush portion 42 can be sucked while performing broom-cleaning by the broom brush portion 42. In this embodiment, the vicinity of the broom brush portion 42 is opened in the gap between brush bristles 44 of the broom brush portion 42.

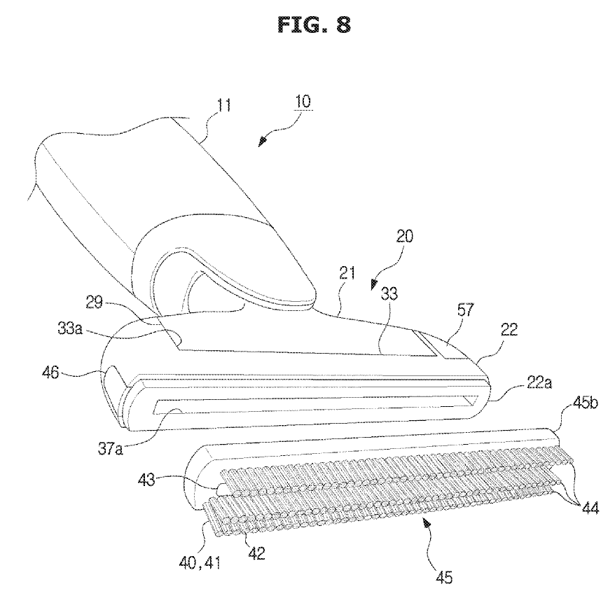

The broom brush portion 42, as shown in FIG. 8, is composed of an attachment brush 45 which is detachably attached to a second part main body 22a. The attachment brush 45 has a base portion 45b that can be fixed to the second part main body 22a and a plurality of brush bristle 44 implanted on the base portion 45b.

The second part main body 22a is provided with a release button 46 for forcibly releasing the attachment brush 45.

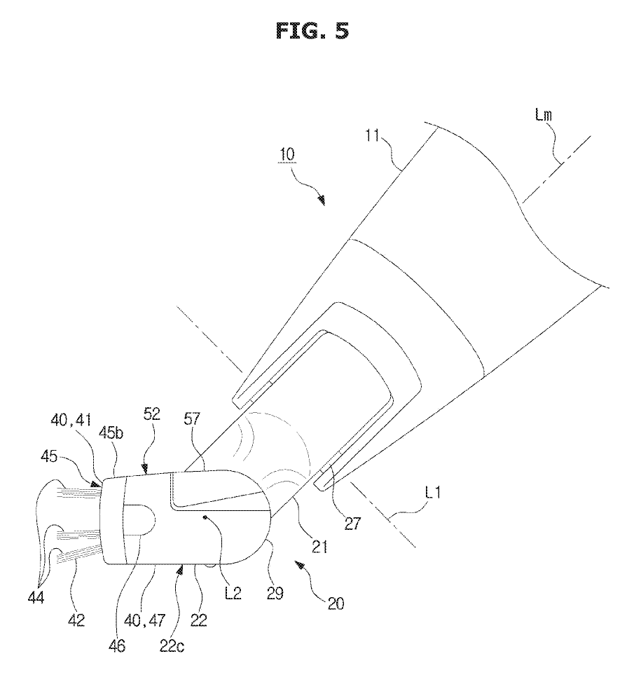

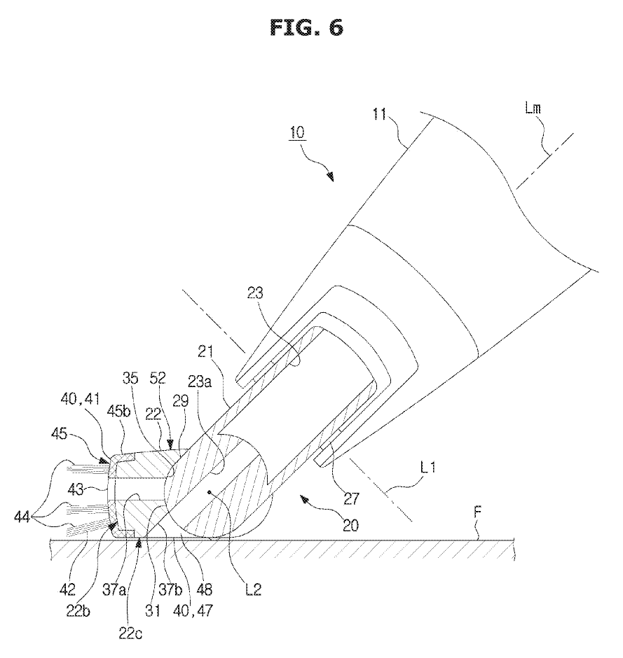

As shown in FIGS. 5 and 6, the normal cleaning function unit 47 has a normal suction port 48 formed of an opening of the second air passage 37b formed in the side surface 22c of the second part 22. In the present embodiment, some of the brush bristles 44 in the broom brush portion 42 also serve as the fixed brush portion of the normal cleaning function unit 47.

A plurality of second air passages 37a and 37b for communicating between the first air passage 23 provided in the first part 21 and the respective cleaner function unit 40 is provided in the second part 22. The communicating passage 23a of the first air passage 23 is provided so as to pass through the arc-shaped portion 31 of the second hinge portion 29 so that each of the second air passages 37a and 37b is opened and provided in the arcuate groove 35. An opening of the end portion of the second air passage 37a is the broom suction port 43.

The second air passage 37a provided between the broom function unit 41 and the arcuate groove 35 may be provided with a long through-hole in the direction of the second rotation axis L2.

The second air passage 37b provided between the normal cleaning function unit 47 and the arcuate groove 35 is formed in a surface mounting portion formed by removing an end portion corresponding to the side of the second hinge portion 29 of the second part 22.

The second air passages 37a and 37b are provided independently of each other.

The second part 22 is rotated by the second hinge portion 29 so that the inclination angle of the second part 22 can be varied in multiple stages around the second rotation axis L2 while changing the inclination with respect to the first part 21.

It is possible to arrange to use some of the plurality of cleaner function units 40 provided on the second part 22 by changing the inclination angle of the second part 22 with respect to the first part 21, and the second air passages 37a and 37b corresponding to the plurality of cleaner function units 40 respectively, can communicate with the first air passage 23.

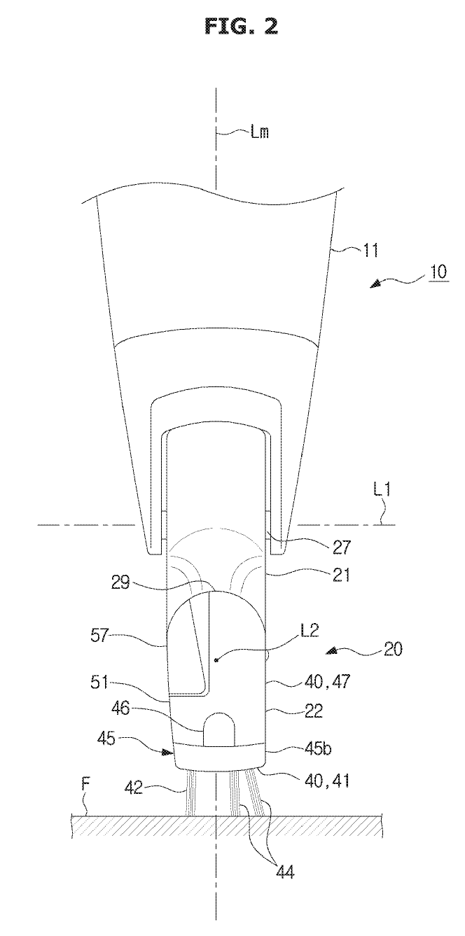

In the present embodiment, as shown in FIGS. 2 and 3, a fixed posture 51 in which the second part 22 is arranged to be fixed such that the inclination angle of the second part 22 with respect to the first part 21 is not changed, and as shown in FIGS, 5 and 6, a variable posture 52 in which the second part 22 is arranged by freely changing the inclination angle of the second part 22 with respect to the first part 21 within a predetermined inclination range, can be selected. When the second part 22 is arranged to be the variable posture 52, the inclination angle of the second part 22 with respect to the first part 21 is easily adjusted within the predetermined inclination range.

In the present embodiment, the fixed posture 51 is set such that the second part 22 is disposed such that the thickness direction of the second part 22 is perpendicular to the axis Lm. The variable posture 52 is set such that the second part is disposed such that the thickness direction of the second part 22 is inclined with respect to the axis Lm.

On the other hand, at the connecting portion of the second hinge portion 29 of the second part 22, an air passage switch is constituted.

That is, the arc-shaped portion 31 is provided with the communicating passage 23a of the first air passage 23, and the arcuate groove 35, which rotates while contacting the arc-shaped portion 31, is provided with the second air passages 37a and 37b corresponding to the each of the cleaner function unit 40. When the inclination angle of the second part 22 with respect to the first part 21 is changed, the arc-shaped portion 31 and the arcuate groove 35 are rotated with each other and the positional relationship between the communicating passage 23a and the plurality of second air passages 37a and 37b is changed.

In a predetermined relationship, one of the plurality of second air passages 37a and 37b is communicated with the first air passage 23 and an opening of the arcuate groove 35 of the other one of the plurality of second air passage 37a and 37b is blocked by a surface of the arc-shaped portion 31. The suction force of the cleaner main body 11 is applied to some of the cleaner function unit 40 in which the communicating passage 23a of the first air passage 23 and the second air passages 37a and 37b are communicated with each other.

In the present embodiment, the broom function unit 41 can be used as the fixed posture 51 as shown in FIGS. 1 to 3. At this time, the second air passage 37a opened to the broom suction port 43 adjacent to the broom brush portion 42 communicates with the communicating passage 23a of the first air passage 23 and the second air passage 37b connected to the normal suction port 48 of the normal cleaning function section 47 is blocked.

In addition, the normal cleaning function unit 47 can be used as the variable posture 52 as shown in FIGS. 4 to 6. The second air passage 37b opened to the normal suction port 48 of the normal cleaning function section 47 communicates with the communicating passage 23a of the first air passage 23 and the second air passage 37a connected to the broom suction port 43 adjacent to the broom brush portion 42 is blocked.

In the present embodiment, a position regulator 53 is provided between the inner side surface portions 33a on both sides in the lateral width direction of the connecting concave portion 33 of the second part 22 and the end portions on both sides in the lateral width direction of the arc-shaped portion 31 of the second hinge portion 29 to regulate the position of the inclined direction of the second part 22 with respect to the first part 21.

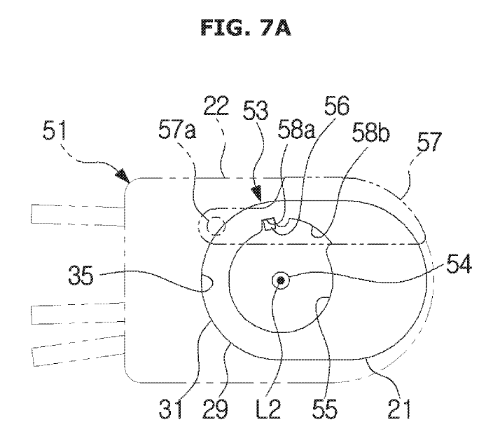

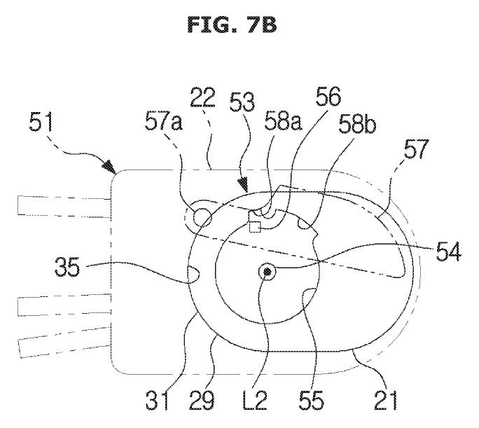

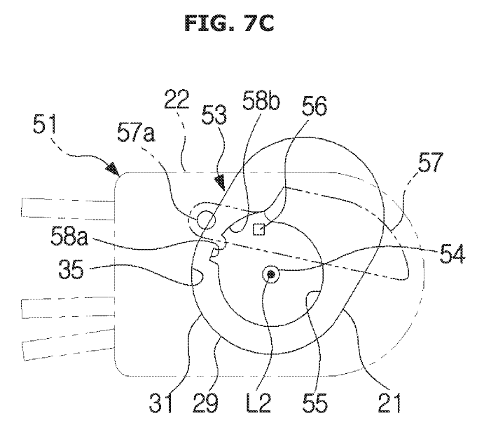

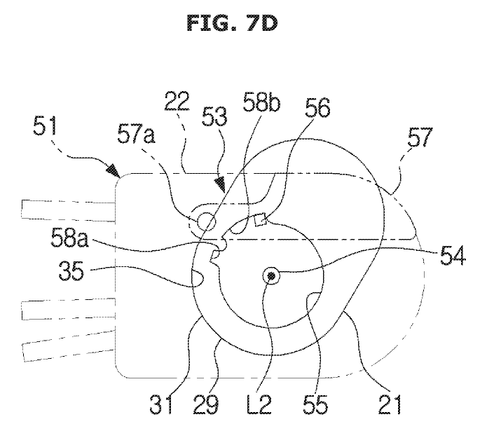

FIG. 7 is a view illustrating an operation of a position regulator 53, particularly, 7A shows a state in which the second part 22 is arranged in a fixed posture, 7B shows a state in which the position regulation is released, 7C shows a state in which the second part 22 is inclined to a variable posture 52 after releasing the position regulation, and 7D shows a state in which the second part 22 is arranged in the variable posture 52.

The position regulator 53 includes a shaft supporting portion 54, a position regulating hole 55 recessed in the width direction at the end portion of the arc-shaped portion 31 of the second hinge portion 29, a movable pin 56 provided on the inner side surface portions 33a on both sides in the width wide direction of the connecting concave portion 33 of the second part 22 and inserted into the position regulating hole 55, and a foot button 57 provided on the second part move the movable pin 56 in the radial direction. The shaft supporting portion 54 is provided at the end portions on both sides in the widthwise direction of the arc-shaped portion 31 of the second hinge portion 29, and is rotatably connected to the inner side surface portions 33a on both sides in the widthwise direction of the connecting concave portion 33 of the second part 22 along the second rotation axis L2.

Positioning portions 58a and 58b are provided in the position regulating hole 55 so as to be recessed outward in the radial direction around the circumference in order to regulate the inclination position of the second part 22 with respect to the first part 21.

The positioning portions 58a and 58b are disposed so as to correspond to the fixed posture 51 and the variable posture 52 of the second part 22. The positioning portion 58a corresponding to the fixed posture 51 is provided so as to be short in the circumferential direction so that the movable pin 56 and the positioning portion 58a cannot be displaced relative to each other in the circumferential direction. The positioning portion 58b corresponding to the variable posture 52 is provided long in the circumferential direction so that the movable pin 56 and the positioning portion 58b can be relatively displaced by a predetermined amount in the circumferential direction.

The movable pin 56 protrudes into the position regulating hole 55 from the inner side surface portion 33a on both lateral widthwise sides of the connecting concave portion 33 of the second part 22. The movable pin 56 is displaced in the radial direction to be separable from the positioning portions 58a and 58b and is connected to the foot button 57.

The foot button 57 is rotatably supported on the second part 22 by the support pin 57a and is elastically supported outward by an elastic member (not shown).

In the position regulator 53, normally, the movable pin 56 is engaged with the positioning portions 58a and 58b as shown in FIG. 7A or 7D. In this state, the displacement of the second part 22 in the oblique direction with respect to the second hinge portion 29 is restricted and the change of the inclination angle of the second part 22 with respect to the first part 21 is restricted.

When the foot button 57 of the second part 22 is pushed, the foot button 57 rocks as shown in FIG. 7B or 7C, and the movable pin 56 is displaced radially inward. The engagement between the movable pin 56 and the positioning portions 58a and 58b is released and the regulation of the position of the second part 22 in the oblique direction with respect to the second hinge portion 29 is released. Accordingly, the inclination angle of the second part 22 with respect to the first part 21 can be changed to a desired angle.

The position of the foot button 57 is restored by the elastic member by releasing the foot button 57. The movable pin 56 is displaced outward in the radial direction and the movable pin 56 is engaged with the positioning portions 58a and 58b so that the inclination angle of the second part 22 with respect to the first part 21 is maintained at a desired angle.

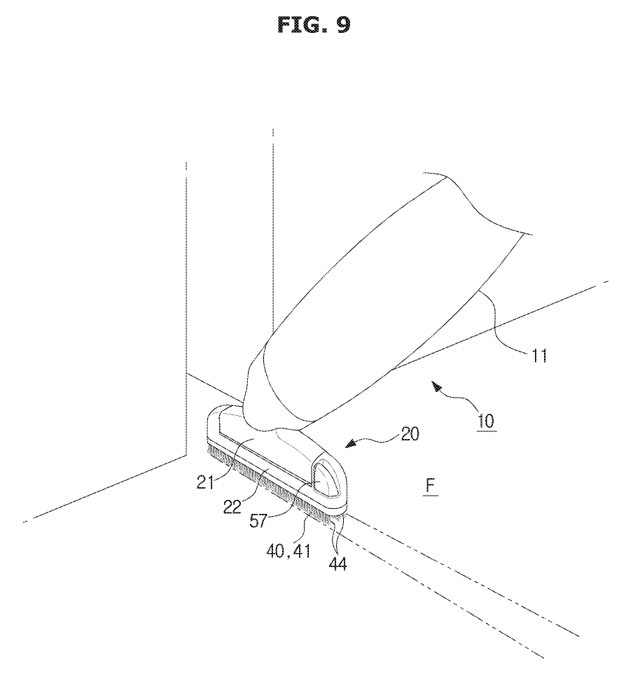

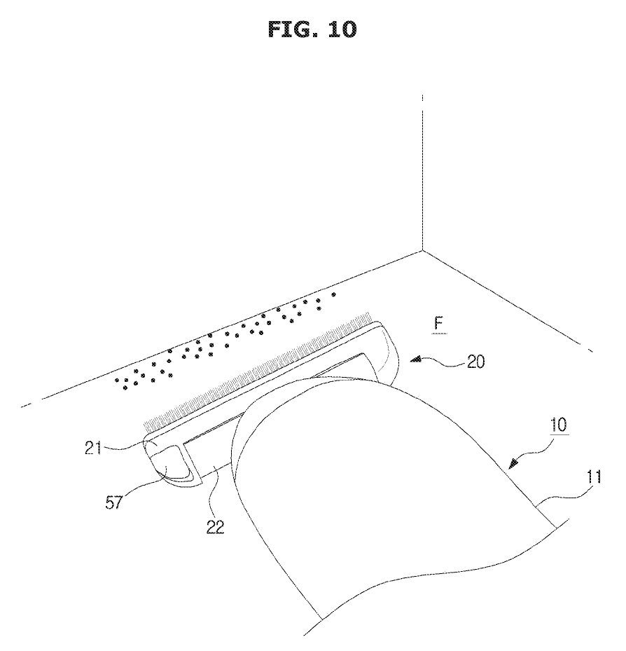

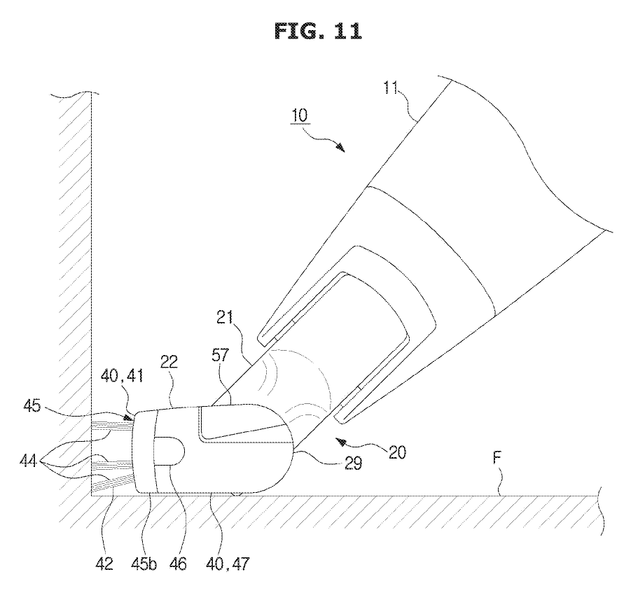

FIG. 9 is a perspective view illustrating a state in which the broom function unit of the vacuum cleaner head according to an embodiment is used, FIG. 10 is a perspective view illustrating a state in which the normal cleaning function unit of the vacuum cleaner head according to an embodiment is used and FIG. 11 is a side view illustrating a state in which the normal cleaning function unit of the vacuum cleaner head according to an embodiment is used.

In order to use the vacuum cleaner head 20 as a broom-cleaning mode, the second part 22 is disposed in the fixed posture 51 as shown in FIGS. 1 to 3 and the broom function unit 41 is positioned in the downward direction. In this state, the second part 22 is disposed in a standing state without being inclined with respect to the first part 21. The first part 21 can freely rotate with respect to the cleaner main body 11 about the first rotation axis L1.

In this state, the user grips a handle (not shown) and performs broom-cleaning while suctioning dust or garbage on the floor F or a narrow gap as shown in FIG. 9, for example. At this time, since the broom function unit 41 is used in a state where the second part 22 is standing up, it is possible to perform cleaning of a narrower gap.

Next, in order to use the vacuum cleaner head 20 as a normal cleaning mode, the foot button 57 of the position regulator 53 is pressed to tilt the second part 22 with respect to the first part 21.

As shown in FIGS. 10 and 11, the normal cleaning function unit 47 is tilted with respect to the first part 21 to oppose the floor F. In this state, the normal cleaning function unit 47 is moved along the floor F to suction dust or waste from the floor into the normal suction port 48 to clean the floor in the normal cleaning mode.

At this time, brush bristles 44 of the broom brush portion 42 is also used as the fixed brush portion of the normal cleaning function unit 47. Therefore, when cleaning the vicinity of the wall using the normal cleaning function unit 47, it is possible to suction dust or garbage near the wall while sweeping dust or garbage near the wall by broom-cleaning

According to the vacuum cleaner head 20 of the above-described embodiment, by changing the inclination angle of the second part 22 having the plurality of cleaner function units 40, it is possible to switch to the cleaner function unit 40 to be used. Accordingly, it is possible to implement a plurality of cleaning functions with a single vacuum cleaner head 20, and it is possible to perform efficient cleaning by omitting a head exchange operation for each cleaning function.

Particularly, by changing the inclination angle of the second part 22, some of the plurality of cleaner function units 40 can be used and the corresponding second air passages 37a and 37b are communicated with the first air passage 23. Accordingly, it is easy to install the plurality of cleaner function units 40 having different cleaning functions on the second part 22 and the cleaning mode can easily be changed by a single vacuum cleaner head 20.

Therefore, it is possible to implement a plurality of functions having different cleaning purposes, and the cleaning mode can be changed, so that the cleaning can be efficiently performed without inconvenience.

According to the vacuum cleaner head 20 of the present embodiment, the fixed posture 51 in which the inclination angle of the second part 22 is not changed and the variable posture 52 in which the inclination angle of the second part 22 can freely be changed are selectable.

The cleaner function unit 40 to be used can be fixedly disposed in the fixed posture 52 and the cleaner function unit 40 to be used can be freely tilted in the variable posture 52. This makes it easy to implement the function of each cleaner function unit 40 by appropriately selecting the posture according to the function of the cleaner function unit 40 to be used.

According to the vacuum cleaner head 20 of the present embodiment, the fixed posture 51 and the variable posture 52 are provided at positions where the inclination directions of the second part relative to the first part 21 are different from each other.

It is therefore possible to select the cleaner function unit 40 to be used by appropriately adjusting the inclination angle of the second part 22 with respect to the first part 21 and to arrange the second part 22 in a state according to the function of the cleaner function unit 40. Accordingly, the selection and placement of the cleaner function unit 40 can be performed at the same time by adjusting the inclination angle of the second part 22, so that efficient cleaning can be performed without further troubles.

According to the vacuum cleaner head 20 of the present embodiment, since the broom function unit 41 having the broom brush portion 42 can be used as the fixed posture 51, the inclination angle of the broom brush portion 42 is not changed upon the broom-cleaning. Therefore, the broom brush portion 42 can be accurately contacted at a desired position, thereby making it easy to perform the broom-cleaning.

Since the normal cleaning function unit 47 having the no al suction port 48 can be used as the variable posture 52, it is easy to keep the normal cleaning function unit 47 in a state where the normal cleaning function unit 47 is arranged along the floor F when the normal cleaning function unit 40 sucks the dust of the floor F while moving. Therefore, it is easy to clean the floor F.

It is convenient to use in any Meaning mode.

According to the vacuum cleaner head 20 of the present embodiment, the second part 22 has a flat shape and the broom brush portion 42 is provided on the side surface corresponding to the thickness of the second part 22.

Therefore, when the broom function unit 41 is arranged to be usable and the vacuum cleaner head 20 is moved along the long-side of the second part 22, even a narrow gap corresponding to the thickness of the second part 22 can be broom-cleaned.

Meanwhile, by moving the second part 22 of the vacuum cleaner head 20 in the short-side direction of the side surface, it is possible to perform broom-cleaning of the wide floor F.

Therefore, even the narrow gap or the wide floor F can be cleaned by broom-cleaning.

According to the vacuum cleaner head 20 of the present embodiment, at least a portion of the brush bristles 44 of the broom brush portion 42 serve as the fixed brush portion of the normal Meaning function unit 47, so that the number of components can be regulated.

According to the vacuum cleaner head 20 of the present embodiment, when deterioration occurs by use of the brush bristles 44 of the broom brush portion 42, only the attachment brush 45 is replaced and the second part main body 22a can be used as it is. Accordingly, the vacuum cleaner head 20 can be used for a long period of time.

According to the vacuum cleaner head 20 of the present embodiment, the second part main body 22a is provided with the release button 46 for releasing the attachment brush 45, so that the attaching/detaching of the attachment brush 45 is easy.

According to the vacuum cleaner head 20 of the present embodiment, the vacuum cleaner head 20 has the position regulator 53 for regulating the position of the second part 22 in the oblique direction and the foot button 57 for releasing regulation of the second part 22 to change inclination angle of the second part 22 by pressing the position regulator 53 with the foot. The second part 22 can be moved to another inclined angle position by releasing the position regulation of the inclination angle of the second part 22 by pressing the foot button 57 with the foot. Thus, the adjustment of the position of the inclination angle of the second part 22 can be performed by using the foot, so that the operation can be simplified.

As described above, the vacuum cleaner head 2.0 according to an embodiment of the present disclosure has been described. However, the present disclosure is not limited to the above-described embodiment, and can be appropriately changed without departing from the spirit of the present disclosure.

For example, in the above embodiment, the broom function unit 41 and the normal cleaning function unit 47 are provided as the plurality of the vacuum cleaner function units 40. However, it is also possible to install three or more vacuum cleaner function units 40.

Although the vacuum cleaner head 20 is directly connected to the vacuum cleaner main body 11 in the above description, the vacuum cleaner head 20 may be connected to the cleaner main body 11 through a hose or the like without the direct connection.

Although the vacuum cleaner head 20 is formed of only the first part 21 and the second part 22 in the above description, the vacuum cleaner head 20 can be connected to other components.

The first part 21 and the second part 22 are connected to the second hinge portion 29 so that the angle of inclination of the second part 22 relative to the first part 21 can be changed. However, it is possible to change the inclination angle differently from the connecting portion between the first part 21 and the second part 22.

For example, the first part 21 and the second part 22 may be connected to each other by a connecting member having a bellows-like structure to change the inclination angle.

Although the first air passage 23 and the main air passage 13 communicate with each other through the air passage connecting portion 25 in the above description, the first air passage 23 and the main air passage 13 may be in direct communication with each other.

While the present disclosure has been particularly described with reference to exemplary embodiments, it should be understood by those of skilled in the art that various changes in form and details may be made without departing from the spirit and scope of the present disclosure.

1. A vacuum cleaner head comprising:
a first part having a first air passage communicating with a main air passage of a cleaner main body; and
a second part having a plurality of cleaner function units provided at different positions and a plurality of second air passages communicating between each of the cleaner function units and the first air passage, the second part being connected to the first part so that the inclination angle of the second part is changeable in multiple steps,
wherein by changing the inclination angle of the second part with respect to the first part some of the plurality of cleaner function units is disposed so as to be usable_{;} and the second air passage is communicated with the first air passage for switching to the some of the plurality of cleaner function units to be used.

2. The vacuum cleaner head of claim 1, wherein the second part is provided so as to be able to select one of a fixed posture in which the inclination angle cannot be changed and a variable posture in which the inclination angle is changeable.

3. The vacuum cleaner head of claim 2, wherein the fixed posture and the variable posture are provided so that the inclination directions of the second part with respect to the first part are different from each other.

4. The vacuum cleaner head of claim 3, wherein the plurality of cleaner function units comprises;
a broom function unit having a broom brush portion and a broom suction port opened adjacent to the broom brush portion; and
a normal cleaning function unit having a normal suction port,
wherein the broom function unit is configured to be usable in the fixed posture and the normal cleaning function unit is configured to be usable in the variable posture.

5. The vacuum cleaner head of claim 4, wherein the second part has a flat shape and the broom brush portion is provided on a front end surface corresponding to the thickness of the second part.

6. The vacuum cleaner head of claim 5, wherein at least a portion of the brushes of the broom brush portion serve as a fixed brush of the normal cleaning function unit.

7. The vacuum cleaner head of claim 6, wherein the broom brush portion is provided as an attachment brush detachably coupled to a second part main body connected to the first part and configured to change the inclination angle in multiple steps.

8. The vacuum cleaner head of claim 7, wherein the second part main body is provided with a release button releasing the attachment brush.

9. The vacuum cleaner head of claim 8, wherein the second part has a position regulator regulating the position of the inclination angle, and the position regulator has a foot button releasing the position regulation of the second part by being pushed with the foot.
